(19) United States
(12) Patent Application Publication
(10) Pub. No.: US 2025/0111964 A1
(43) Pub. Date: Apr. 3, 2025

(54) Single-Part Abrasion Protection on a Line, Comprising a Securing Hook

(71) Applicant: HIRSCHMANN AUTOMOTIVE GMBH, Rankweil/Brederis (AT)

(72) Inventors: Marco VONBUN, Tschagguns (AT); Christian BELLER, Feldkirch (AT); Andreas METZLER, Muntlix (Zwischenwasser) (AT)

(21) Appl. No.: 18/728,538

(22) PCT Filed: Jan. 13, 2023
(86) PCT No.: PCT/EP2023/050786

§ 371 Date: Jul. 12, 2024

(30) Foreign Application Priority Data
Jan. 14, 2022 (DE) 10 2022 000 130.6

(51) Int. Cl. H01B 7/18; F16L 3/12; F16L 57/06

(52) U.S. Cl. CPC H01B 7/1805; F16L 3/12; F16L 57/06

(57) ABSTRACT

The invention relates to an assembly with an abrasion protection element, comprising at least one securing hook for a cable, wherein the element can be secured on an outer jacket of the cable. The invention is characterized in that the abrasion protection element and the at least one securing hook are formed as a single part, and the abrasion protection can be manually latched, in particular in a torsion-proof manner in suitable bores.

The invention relates to an arrangement with an element for an abrasion protection with at least one fastening hook for a cable, wherein the element was fixed on an outer sheath of a cable, in accordance with the features of the preamble of claim one.

It is always necessary to fix cables in their installation location in a suitable manner to prevent them from slipping, wherein such slippage leads to chafing of the outer sheath of the cable and consequently there is a risk that at least one electrical conductor surrounded by the outer sheath of the cable will be exposed. This can lead to short circuits, interruptions, safety hazards for users and similar.

In particular, there is always a need to securely and permanently fix cables in the axis area of a vehicle or within the route of cables in machines and protect them from damage. Such cables are particularly required for the axle wiring of sensors (such as brake wear sensors or similar) or actuators (for example for damping control or similar) or at other positions on a vehicle or machine. Above all, if the anti-lock braking system with its sensors and actuators is to be wired in an axis area of a vehicle, the chafing of an outer sheath of a cable would lead to safety hazards during operation of the vehicle if one of the usually several electrical conductors of the wiring is exposed or interrupted by the chafing.

Therefore, it has long been known in the prior art as an existing standard variant to attach a chafe guard to a line as a two-part design, which is designed as a first element. In a second operation, a clip with a hook for fastening is assembled on this scuff guard as a second element, wherein the scuff guard and thus also the cable are arranged and fastened in a suitable opening, for example a through-opening in a vehicle body panel, as intended and in the correct position by means of the hook.

A known exemplary embodiment of this existing variant described above is shown schematically in FIG. 2.

The object of the invention is to provide an improved arrangement for fixing a cable at its installation location in the intended manner and in the correct position, which avoids the disadvantages mentioned above.

This object is achieved by the features of claim 1.

According to the invention, it is provided that the element for the chafing protection and the at least one fastening hook are designed in one piece and that the chafing protection can be engaged by hand, particularly in a twist-proof manner in suitable bores.

The invention is a scuff guard with a fastening hook, which can be engaged by hand, particularly by reh-locking it in suitable bores.

The advantage of the scuff guard according to the invention is that it is designed in one piece and does not have to be assembled or fastened by means of additional clips, as is known.

This means that a line can be advantageously
time-saving,
space-saving,
twist-locked,
without special auxiliary means (manually),
without material mix
   assembled or fastened at a previously defined location.

In a further embodiment of the invention, the arrangement is designed as a one-piece injection-molded element made of plastic. As a result, the arrangement according to the invention can be produced quickly, cost-effectively and automatically in large quantities. For this purpose, a corresponding injection mold is created, injected with plastic and subsequently the arrangement is removed from the injection mold, which can be further processed, i.e. assembled, preferably automatically.

In a further embodiment of the invention, two fastening hooks are provided in the axial direction on the element for the chafe guard, preferably adjacent to one another. These two hooks can, for example, be arranged directly next to the center of the element, at both ends of the element or at any location along the extension of the element. The aim of the presence of two fastening hooks is that these are each inserted into their own opening and rusted, whereby the arrangement according to the invention and thus also the cable is fixed in the correct position at its installation location in accordance with its intended use and, above all, in such a manner that it cannot twist.

In a further embodiment of the invention, the element for the abrasion protection is elongated cylindrical in shape with an axially inwardly extending through-opening for the cable. This has the advantage that one end of the cable can be quickly and easily fed (threaded) through the through-opening. This makes it possible to displace the arrangement according to the invention further over the outer sheath of the cable to the location where it is to be fixed on the outer sheath of the cable. The fixing is achieved, for example, by means of a press fit (which, however, makes displacement over the outer sheath somewhat more difficult), by means of an adhesive process or by means of additional elements (such as cable ties, press sleeves or similar), wherein this is not the preferred embodiment, as the aim of the invention is to provide a simple one-piece variant and to avoid further elements. The fixing can be carried out alternatively or additionally by means of other joining processes (such as laser welding).

In a further embodiment of the invention, the element has a slot extending axially over a partial length, preferably over the totality of the length of the element for the abrasion protection. The advantage of such a part or entire slot over the axial length of the element is that it can expand slightly when it is pushed over the outer sheath of the cable, so that the displacement process is simplified, but at the same time a corresponding press fit is achieved at the intended fixing location. The slot can be closed in the initial state and widened when the element for the abrasion protection is pushed on and finally fixed. However, it can also be slightly widened from the outset and then widened further when the element is displaced and fixed for abrasion protection.

In a further embodiment of the invention, the arrangement is arranged on the outer sheath of the cable using a plastic injection molding process. This means that the cable is inserted into a suitable injection mold, which also forms the shape of the arrangement according to the invention, plastic is injected into this corresponding mold and subsequently the cable is removed with the arrangement with the chafing protection and the at least one fastening hook molded onto the outer sheath. This advantageously represents a fast production of the cable including its at least one arrangement for chafe protection. However, handling during production is somewhat more complicated and the arrangement for the abrasion protection cannot be subsequently changed in its position relative to the outer sheath of the cable.

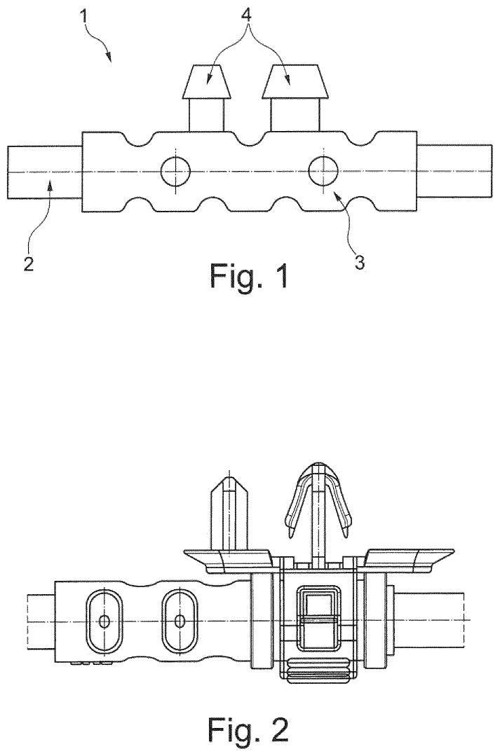

An exemplary embodiment of an arrangement with an abrasion protection according to the invention is described below and explained with reference to FIG. 1.

FIG. 1 shows the arrangement 1 according to the invention. This arrangement 1 has a cable 2 (also referred to as a line), wherein at least one electrical conductor, and often more than two electrical conductors insulated from one another, are arranged within an unspecified outer sheath of the cable 2.

According to the invention, an element 3 for an abrasion protection is arranged on the cable 2. The element 3 advantageously consists of a plastic material. In this exemplary embodiment, it has two fastening hooks 4 arranged adjacent to one another for the torsion-proof mounting of the cable 2 at its intended installation location. The distance between the fastening hooks 4 can also be greater. As shown, they can extend symmetrically from element 3, but also asymmetrically (such as not mirror-inverted to the center of element 3, different lengths and the like). Each fastening hook 4 has an approximately trapezoidal cross-section at its end, whereby an undercut is formed at the transition from the trapezoidal cross-section to a cylindrical area of the fastening hook 4. With this preferably completely circumferential undercut, the arrangement 1 and thus also the cable 2 is fixed at its installation location when the trapezoidal end of the respective fastening hook 4 has been performed through an opening at the installation location, particularly a bore in a body panel of a vehicle, and the undercut is deposited behind the body panel. The trapezoidal cross-section, in particular the smaller diameter of the fastening hook 4 at its free end, has the advantage that the fastening hook or hooks 4 can pass through the through-opening in a targeted manner, particularly if the diameter of the through-opening is slightly larger than the diameter of the trapezoidal free end of the fastening hook 4, wherein, however, it must be ensured that the larger diameter of the trapezoidal area of the fastening hook 4, which points into the cylindrical part of the fastening hook 4 in the direction of the element 3 for the abrasion protection, is larger than the diameter of the through-opening.

In the exemplary embodiment in accordance with FIG. 1, circumferential indentations (e.g. grooves) are still shown in element 3, as are round cut-outs. The circumferential indentations have the advantage that the element 3 can deform in a slightly curved shape, so that vibrations, temperature differences, tolerances and the like can be easily compensated for after mounting, particularly in the axis area of a vehicle. The at least one cut-out (designed as a bore, for example) or more than the two cut-outs shown also serve this purpose, but alternatively or additionally, like the circumferential indentations, they also save weight and material and thus protect the recourses.

FIG. 2 shows an existing design variant.

### LIST OF REFERENCE SIGNS

1. arrangement
2. cable
3. element for abrasion protection
4. mounting hooks

1.-6. (canceled)

7. An arrangement with an element for an abrasion protection with at least one fastening hook for a cable, wherein the element can be fixed on an outer sheath of the cable, wherein the element for the abrasion protection and the at least one fastening hook are designed in one piece and the abrasion protection can be engaged by hand, particularly in a twist-proof manner, in suitable bores.

8. The arrangement according to claim 7, wherein the arrangement is designed as a one-piece injection-molded element made of plastic.

9. The arrangement according to claim 7, wherein two fastening hooks are provided adjacent to one another in the axial direction on the element for the abrasion protection.

10. The arrangement according to claim 7, wherein the element for the abrasion protection is of elongate cylindrical design with an axially inwardly extending through-opening.

11. The arrangement according to claim 10, wherein the element has a slot extending axially over a partial length, preferably over the totality of the length of the element.

12. The arrangement according to claim 7, wherein the arrangement is arranged immovably on the outer sheath of the cable in a plastic injection molding process.
